(19) United States
(12) Patent Application Publication
(10) Pub. No.: US 2022/0179853 A1
(43) Pub. Date: Jun. 9, 2022

(54) METHOD AND QUERY MODULE FOR QUERYING INDUSTRIAL DATA

(71) Applicant: SIEMENS AKTIENGESELLSCHAFT, München (DE)

(72) Inventor: Rainer Schiekofer, Nürnberg (DE)

(21) Appl. No.: 17/599,550

(22) PCT Filed: Mar. 29, 2019
(86) PCT No.: PCT/EP2019/058065

§ 371 Date: Sep. 28, 2021

(51) Int. Cl. G06F 16/2452; G06F 16/25

(52) U.S. Cl. CPC G06F 16/2452; G06F 16/258

(57) ABSTRACT

A method for querying industrial data amongst a plurality of industrial entities is provided. More specifically, the method is for querying industrial data stored in a triple store, using a transformed query expression, where the triple store includes an aggregated ontology of industrial data. Efficient querying of an aggregated and transformed OPC UA information model is enabled. Query operations imposed to a plurality of industrial entities including skill-matching, onboarding of devices into machinery, and data-mining are allowed to be performed.

This application is the National Stage of International Application No. PCT/EP2019/058065, filed Mar. 29, 2019. The entire contents of this document are hereby incorporated herein by reference.

### TECHNICAL FIELD

The present embodiments relate to a method for querying industrial data amongst a plurality of industrial entities. More specifically, the present embodiments relate to a method for querying industrial data stored in a triple store, using a transformed query expression, where the triple store includes an aggregated ontology of industrial data.

### BACKGROUND

Industrial automation system components of the past have traditionally been interconnected by specialized networks using standard industrial protocols for access and data exchange. The development of present and future automation systems has put considerable focus on exchanging semantically enriched information aiming for a realization of flexible manufacturing scenarios.

In order to overcome a still present low-level communication of signals in industrial automation systems, a protocol entitled OPC UA has been proposed for enhancing field-level communication to a semantic level. Open platform communications unified architecture (OPC UA) is an industrial standard protocol of the OPC Foundation for manufacturer-independent communication with the purpose of interchanging industrial data (e.g., in process automation).

An information model of OPC UA features a semantically enriched and graph-based data structure that is dedicated to automation purposes. However, OPC UA rather defines concepts for expressing semantic descriptions within the specification documents, which provides that a formal semantic representation is lacking. The lack of formal semantic representation has a major drawback in that querying within an OPC UA information model is intricate. Although OPC UA defines a query language for accessing the information model, no framework for implementing query requests exists to date, not least due to the high complexity imposed for querying the semantic descriptions scattered within the information model of OPC UA.

### SUMMARY AND DESCRIPTION

Accordingly, there is a need in the art to facilitate a query being expressed by a query language for accessing an information model for automation purposes, obliviating the high complexity imposed for querying the semantic descriptions scattered within the information model.

Further, there is a need in the art to facilitate a query amongst a plurality of information models stored within a plurality of industrial entities.

One preliminary consideration according to the present embodiments in addressing existing problems with the considered information model is that querying within scattered semantics of presently applied industrial information models is be replaced in favor of a query in a formal semantic representation.

Embodiments herein generally involve a query within an ontology THAT is understood as a formal semantic representation. Ontologies readily provide the desired capabilities for querying and analyzing the information model using sophisticated standard tools adapted to the formal representation of the ontology.

In one embodiment, a computer-implemented method for querying industrial data is suggested, where a first query expression is received by a query module. The first query expression is expressed by a query language for accessing a semantically enriched and graph-based information model for automation purposes, particularly expressed by an OPC UA query language.

Subsequently, the first query expression is transformed into a second query expression that is expressed by a query language used for accessing a triple store information model according to a Resource Description Framework (RDF) format, particularly expressed by the query language SPARQL. SPARQL is a recursive acronym for SPARQL Protocol and RDF Query Language. Transforming the first query expression into the second query expression includes an act of retrieving at least one operand of the first query expression, applying at least one transformation rule for the at least one operand, and replacing the at least one operand by at least one statement of the second query expression (e.g., being in conformance with the query language used for accessing the triple store information model according to the RDF format).

Subsequently, the second query expression is used for performing a query on a triple store. The triple store includes an aggregated ontology of the industrial data. Eventually, the query result is returned to the client.

According to an embodiment, a query module including a processor and a data storage device having stored thereon a computer executable program code is provided. The data storage device may be implemented within or external to the processor.

According to a further embodiment, a non-transitory computer-readable storage medium having stored thereon computer executable program code is provided.

### BRIEF DESCRIPTION OF THE DRAWINGS

FIG. 1 shows a simplified block diagram of a query module according to an embodiment, the query module being connected with a number of clients and industrial entities;

FIG. 2 shows a graphical representation of a logic tree structure for an exemplary first OPC UA query according to the state of the art; and

FIG. 3 shows a graphical representation of a logic tree structure for an exemplary second OPC UA query according to the state of the art.

### DETAILED DESCRIPTION

The evolvement of networking between computers and computing devices has eventually led to an=»Internet of Things«. Internet of Things in an industrial context is a concept that functionally connects Things, or industrial entities, in order to achieve a composite interaction (e.g., for tracking, monitoring, and management of a more complex industrial entity). Industrial entities may vary in terms of complexity, ranging from single sensors, devices, equipment, systems, sub-systems, or eventually complete processes in an industrial environment.

Industrial entities are typically equipped with ample resources of storage, communication, and computation. Leveraging these entities to descend the concept of cloud close to the users has been given the name of fog networking. Fog networking is a technology operating to use resources already present at the cloud edge to provide a network that may support low latency and backbone bandwidth savings.

In the area of factory automation, OPC Unified Architecture or OPC UA is one of the most important standards for device communication and promised to lift low-level signal exchange schemes onto a semantic level, contributing to the realization of flexible manufacturing scenarios.

In the OPC UA information model, every entity in the address space is a Node. To uniquely identify a node, each node has a NodeId including three elements (e.g., a NamespaceIndex, an IdentifierType, and an Identifier).

In the following, compound names with one or more medial capitals (e.g., a compound name »TypeDefinitionNodes«) are used to refer to authoritative names used in the specification »OPC Unified Architecture« of the OPC Foundation. These authoritative names are assumed to be known and for a person skilled in the art. Hereinafter, these authoritative names are, therefore, introduced without explanation.

Companion specifications are used to define domain-specific semantic models or schemas extending the OPC UA information model. These companion specifications are typically developed by domain experts, standardization bodies, or industrial machine suppliers.

In previous years, most of the companion specifications were developed to map other existing industrial communication standards to OPC UA, including AutomationML, PLCOpen, ISA-95, etc. These exiting standards are more or less generic and try to solve the problem of semantic interoperability on an abstract layer.

However, these existing industrial communication standards may only be considered as a first step to semantic interoperability. For example, standardizing the notion of a »Thing« and a concept how skills of these Things are to be exposed, does not yet serve needs of current industrial applications like automatic skill-matching.

It is to be expected that semantics of particular skills (e.g., drilling or clamping) will be standardized in the near future. A promising approach to standardize domain-specific semantics for a huge part of the automation domain (e.g., plastics and rubber machinery, machine vision, robotics, powertrain, weighing, CNC, etc.) is envisaged by a mechanical engineering industry association entitled VDMA (e.g., Verband Deutscher Maschinen- and Anlagenbau in German). The developed domain-specific semantics are going to be standardized within OPC UA Companion Specification, leading to a new level of semantic interoperability in the automation domain.

Accordingly, it is to be assumed that the automation domain will be faced with huge standardized OPC UA information models including detailed descriptions of the underlying industrial entities. This enables significant opportunities for a lot of use cases, including, for example, a development of applications for analytics or human machine interfaces, using standardized information models. Such applications may be deployed on each industrial entity without additional engineering effort.

However, efficient query operations within such information models are still lacking in the art. Without efficient query operations, an application on an aggregating layer (e.g., an edge or cloud application) is unable to determine data points in order to bind these data points within the aggregating layer application. Such application on an aggregating layer may exemplarily include predictive maintenance applications, which require data points of field values (e.g., temperature, power consumption, etc.), of a machine or another industrial entity to be monitored for predictive maintenance.

Although OPC UA itself offers a query service for accessing the graph-based information model information model of OPC UA, this service has proved to be impracticable, not least due to the high complexity imposed for querying the semantic descriptions scattered within the data model of OPC UA. Specifically, searching the graph node by node for each application is tedious. Further, thousands of OPC UA nodes would have to be searched by hundreds of applications on an aggregating layer, searching the graph in parallel, thereby exhausting the capabilities of any system hosting the graph.

Another problem in the art is that the specific query language for the OPC UA query service is of such a disproportionately complex nature so that publishers have been even compelled to introduce an internal domain-specific language for constructing OPC UA queries, as proposed by a publication of Goldschmidt, T. and Mahnke, W.: An Internal Domain-Specific Language for Constructing OPC UA Queries and Event Filters. The embodiments described hereinafter generally abstain from querying within the scattered nature of semantics within the OPC UA information model in favor of a query in a formal semantic representation.

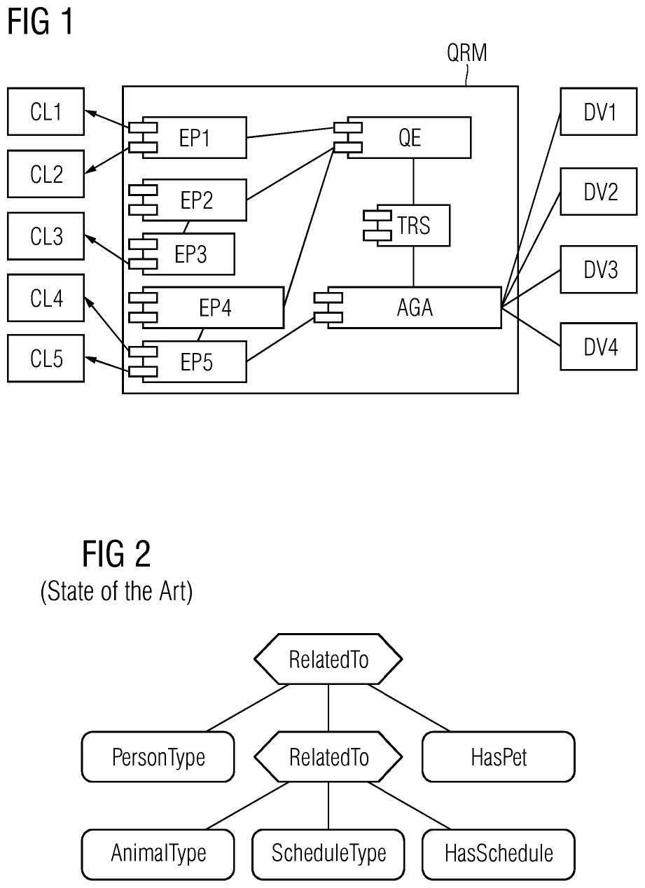

FIG. 1 shows a simplified block diagram of a query module QRM according to an embodiment. The query module QRM may be located within, or hierarchically assigned to, an aggregating layer of an industrial network (e.g., implemented by an edge or cloud application or integrated within an edge or cloud controller).

The query module QRM includes a query engine QE. Further on, a triple store TRS, an aggregated address space AGA, and a number of endpoints EP1, EP2, . . . , EP5 are included or assigned to the query module QRM. Although in FIG. 1 the triple store TRS, the aggregated address space AGA, and the number of endpoints EP1, EP2, . . . , EP5 are drawn to be included within the query module QRM, the triple store TRS, the aggregated address space AGA, and the number of endpoints EP1, EP2, . . . , EP5 may alternatively be located on any desired location outside the realm of the query module thereby remotely exchanging data to support query operations according to the embodiments. Likewise, the aggregated address space AGA and the triple store may alternatively be organized individually or combined in a database system inside or outside the query module QRM.

The endpoints EP1, EP2, . . . , EP5 are acting as logical interfaces that may be at least temporarily assigned to one or more clients demanding a query operation or receiving a query result. Additionally or exclusively (e.g., in the case of a second endpoint EP2 EP4 and a fourth endpoint EP4), these endpoints are connected internally within the query module QRM.

The endpoints EP1, EP2, . . . , EP5 exchange query messages (e.g., receive queries and return query results) in different query languages. In the exemplary embodiment as depicted in FIG. 1, a first endpoint EP1 exchanges query message in the query language SPARQL. The second endpoint EP2 is internally connected in order to transform query messages formulated in a third-party query language to the query language SPARQL. A third endpoint EP3 exchanges query message in the third-party query language, forwarding these messages to the second endpoint EP2 for transforming the query message exchange from and into SPARQL. A fifth endpoint EP5 exchanges query message in an OPC UA query language, forwarding these messages to the fourth endpoint EP4 for transforming the query message exchange from and into SPARQL.

In other words, the endpoints EP1, EP2, . . . , EP5 provide a logical interface (e.g., internal or external) configured for an exchange of query message in a desired query language. Optionally, the endpoints EP1, EP2, . . . , EP5 are operated to transform query messages from one query language into another query language. Eventually, query messages of any kind are transformed from and to SPARQL, which may be used in the core of the query module QRM, the query engine QE, for internal processing according to the embodiments.

The SPARQL query engine QE executes query requests delivered by the endpoints EP1, EP2, . . . , EP5 against the triple store TRS. The query engine QE according to an embodiment is implemented with Apache Jena, an open source semantic web framework for Java along with Fuseki, a SPARQL query engine with an additional web interface, supporting SPARQL for querying.

On the left side of FIG. 1, a plurality of clients CL1, CL2, . . . , CL5 is shown. Each client CL1, CL2, . . . , CL5 is assumed to exchange query messages in a query language supported of the endpoint EP1, EP2, . . . , EP5 to which the respective client CL1, CL2, . . . , CL5 is connected to.

On the right side of the FIG. 1, a plurality of devices or industrial entities DV1, DV2, . . . , DV4 is shown. A respective—server (not shown) operating in each at least one of the industrial entities DV1, DV2, . . . , DV4 is assumed to be communicatively connected to the aggregated address space AGA. The aggregated address space AGA is synchronized with the industrial entities DV1, DV2, . . . , DV4 or with a further aggregating server (not shown) and offers access to the OPC UA graph of each industrial entity DV1, DV2, . . . , DV4 or to the aggregating server (not shown), including live data (e.g., real-time process data accrued in and delivered by the industrial entities DV1, DV2, . . . , DV4).

The triple store TRS includes an OPC UA information model in the form of an aggregated ontology. This aggregated ontology of industrial data is a result of mapping the OPC UA information model provided by the aggregated address space AGA and delivered to an ontology representation, expressed by a web ontology language such as OWL. Details of this mapping have been described in an International Patent Application entitled “A method for transforming a data model for automation purposes into a target ontology,” serial number PCT/EP2018/081938, which was filed by the same applicant on Nov. 20, 2018, the application being incorporated herein by reference in its entirety. In brief, the mapping according to this International Application is provided as follows: All Type-Nodes including InstanceDeclarations except ReferenceTypes are mapped to OWL classes; ReferenceType-Nodes are mapped to OWL object properties; Attributes are mapped to OWL data properties and annotation properties; The BrowseName-Attribute of most InstanceDeclarations is mapped to OWL object properties; Instances are mapped to OWL individuals; The HasTypeDefinition-ReferenceType is mapped to OWL type assertions; and The HasSubtype-ReferenceType is mapped to subClassOf and subPropertyOf axioms, depending on the source concept.

Turning back to the description of the query module QRM depicted in FIG. 1, the information model expressed by an aggregated ontology and included in the triple store TRS is further described. The ontology included in the triple store TRS includes a static portion and a dynamic portion. The static portion of the OPC UA information model (e.g., Type-Hierarchy) is a result of mapping of the OPC UA information model provided by the aggregated address space AGA and transformed into an RDF representation (e.g., transformed into triples) as a result of an OWL mapping. In a first act, the aggregated address space AGA is gathering the aggregated OPC UA information model amongst the OPC UA servers of the industrial entities DV1, DV2, . . . , DV4, which are delivering a respective OPC UA information model to the aggregated address space AGA. The aggregated OPC UA information model is a result of an aggregation of individual OPC UA information models gathered amongst the industrial entities DV1, DV2, . . . , DV4. In a second act, the aggregated OPC UA information model is transformed by the aggregated address space AGA into an RDF representation and delivered as a static portion of the aggregated ontology to the triple store TRS, where the static portion is consecutively stored.

Static, however, may rather be infinitesimally than holistically and does not provide that the static portion remains unaltered for any period in time. The static portion of the aggregated ontology in the triple store TRS is amended if the underlying OPC UA graph structure is updated. In such an event, which may be triggered by industrial entities newly added to the network, a ModelChangeEvent concept of OPC UA Part 3 may be used instead of periodically browsing the whole graph for distinctions.

The dynamic portion of the OPC UA information model is used to provide actual values (e.g., in OPC UA, the Value-Attribute of a VariableNode, such as temperature), which will be directly accessed on demand by the aggregated address space AGA. The dynamic portion, in other words, includes dynamic assignments of data values gathered from at least one industrial entity DV1, DV2, . . . , DV4 at runtime in response to a query and integrated into the aggregated ontology within the triple store on occurrence of such a query. The separation into a dynamic and a static portion reduces a load of updated requirements imposed to the triple store TRS.

Hereinafter, a transformation of a first query expression formulated in OPC UA into a second query expression is described. The first query expression is assumed to be imposed by the fifth OPC UA client CL5 to the fifth endpoint EP5 and transformed by the fourth endpoint EP4 into the second query expression. After the transformation, the second query expression is generally expressed by a query language for accessing a triple store information model according to a Resource Description Framework RDF format of specially by a SPARQL expression. The transformation includes an act of retrieving one or more OPC UA operands of the first query expression, applying at least one transformation rule for the OPC UA operands, and replacing the operands by at least one SPARQL statement of the second query expression.

The transformation to a SPARQL query expression and the consecutively using a triple-store ontology instead of a graph-based OPC UA information model in favor of querying an OPC UA information mode offers the following advantages: SPARQL queries are way more efficient than browsing an OPC UA graph node by node. SPARQL queries offer more capabilities than OPC UA queries in common use-cases. SPARQL offers a rich set of query features like subqueries, grouping, or federated query. Additionally, SPARQL offers to combine a RelativePath segment with a Filter segment. Different RelativePath segments may be bound to the same intermediary node. All these features are not possible using an OPC UA query. A SPARQL Query is less complicated to formulate. Up to now, an OPC UA query does not offer any toolset to reduce efforts necessary to formulate OPC UA Queries. By contrast, SPARQL queries exemplarily presented hereinafter may be formulated with very low effort compared to an OPC UA query. Existing SPARQL query engines may be used, whereas the OPC UA Query Service offers no implementation to date.

A first example introduced hereinafter relates to an OPC UA Not-Operator (e.g., a Boolean inversion imposed to one argument). According to the transformation rules, the OPC UA operator:
Not_7
   is retrieved and replaced by a SPARQL statement as follows:
FILTER(!OP0)
   Alternatively, by a SPARQL expression including a result variable»?result as follows:
BIND(!OP0 as ?result)

The latter expression is used in cases where the result variable ?result is to be used for a subsequent or concurrent query expression using the result of this query.

A second example introduced hereinafter relates to a Between-Operator (e.g., a comparison of two arguments or operands OP0 and OP1 delivering a Boolean result of TRUE when OP0 is greater than OP1). According to the transformation rules, the OPC UA operator:
Between_8
   is retrieved and replaced by a SPARQL statement as follows:
FILTER(COALESCE((OP0>=OP1) && (OP0<=OP2),false))
   Or, alternatively, by a SPARQL expression including a result variable ?result as follows:
BIND(COALESCE((OP0>=OP1) && (OP0<=OP2),false) as ?result)

Again, the latter expression is used in cases where the result variable ?result is to be used for a further subsequent or concurrent query expression. The COALESCE( ) operator included in this SPARQL expression enforces a false return value if the implicit conversion fails.

The following table shows a substantially complete filterOperator list of OPC UA Part 4 and the corresponding SPARQL mapping.

| OPC UA | |
|---|---|
| filterOperator | SPARQL Mapping |
| Equals | COALESCE((OP0 = OP1), false) |
| IsNull | !BOUND(OP0) |
| GreaterThan | COALESCE((OP0 > OP1), false) |
| LessThan | COALESCE((OP0 < OP1), false) |
| GreaterThanOrEqual | COALESCE((OP0 ≥ OP1), false) |
| LessThanOrEqual | COALESCE((OP0 ≤ OP1), false) |
| Like | COALESCE(REGEX(OP0, OP1), false) |
| Not | !OP0 |
| Between | COALESCE((OP0 ≥ OP1)&&(OP0 ≤ OP2), |
| | false) |
| InList | COALESCE(((OP0 = OP1)\|\| (OP0 = OPn)), |
| | false) |
| And | (OP0&&OP 1) |
| Or | (OP0 \|\| OP1) |
| Cast | OP 1(OP 0) (not complete) |
| OfType | TargetNode a OP0. |
| | FILTER(OP0 = opc: ObjectType \|\| |
| | OP0 = opc: VariableType \|\| EXISTS{ |
| | OP0 rdfs : subClassOf+ |
| | opc: ObjectType} \|\| EXISTS{OP0 |
| | rdfs: subClassOf + opc : VariableType}) |

Hereinafter, a transformation of a first query expression formulated in OPC UA into a second query expression is described. The first query expression is assumed to be imposed by the fifth OPC UA client CL5 to the fifth endpoint EP5 and transformed by the fourth endpoint EP4 into the second query expression.

For transforming the first query expression formulated in OPC UA into the second SPARQL query expression, the fourth endpoint EP4 retrieves at least one of the OPC UA filterOperators stated above within the first query expression and replaces the at least one operand, or OPC UA filterOperator, by at least one statement according to the statements stated in the SPARQL Mapping column of the above shown table. Further transformation rules may be applied.

According to the table shown above, most of the SPARQL operators shall return false if an implicit conversion fails. This is, for example, modelled through a COALESCE statement as shown above.

However, a query executed in OPC UA also implicitly converts, for example, a String value into a Byte value. This is not the case for SPARQL queries. Additional algorithms, not further described herein, may be optionally applied in order to cover all further OPC UA Query conversion rules.

For a similar reason, an OPC UA operator, cast, may not be fully supported, because the data type model of OPC UA is extensible; in contrast, the OPC UA to OWL mapping is limited to certain XSD-Schema types, which are supported by OWL tools. The BitwiseAnd and BitwiseOr filter operators also have no direct counterpart in SPARQL. The RelatedTo filter operator contains up to six operands, which sometimes lead to large SPARQL representations.

Besides few restrictions on some of the OPC UA operators explained above, most of the features of OPC UA Query are covered by a SPARQL query. Further, SPARQL supports additional constructs like if-statements, aggregation, sub-queries and also federated queries, which are not available in OPC UA Query.

The transformation rules defined above enable a transformation of first query expression formulated in OPC UA into a second query expression formulated in SPARQL. The second query expression is expressed by the query language SPARQL, which is capable of accessing a triple store TRS information model according to—a resource description framework (RDF) format. The transforming includes retrieving at least one operand of the first query expression, applying at least one transformation rule for the at least one operand, and replacing the at least one operand by at least one statement of the second query expression.

In the following, two exemplary queries in OPC UA are juxtaposed with respective SPARQL queries after the applying of at least one transformation rule according to the embodiments.

The specification OPC Unified Architecture, Part 4, Annex B defines an example information model for the OPC UA Query Service introducing several different types: a PersonType, including Properties such as Lastname, FirstName, and ZipCode; an AnimalType, including Properties such as Name and Subtypes such as CatType, DogType, and PigType; a ScheduleType, including Properties such as Period and the Subtype FeedingScheduleType.

In addition, a number of OPC UA ReferenceTypes are introduced: a HasChild-ReferenceType to connect a parent to a child of the HasChild-ReferenceType; a HasSchedule-ReferenceType to connect an animal to a schedule of the HasSchedule-ReferenceType; a HasAnimal-ReferenceType to connect a person to an animal of the HasAnimal-ReferenceType including the two subtype-ReferenceTypes Has-FarmAnimal and HasPet to further refine the connection type.

FIG. 2 shows a graphical representation of a logic tree structure for an exemplary OPC UA query illustrated in the specification OPC Unified Architecture, Example B.2.4. In FIG. 2, an Operator Element is symbolized by a respective rounded hexagon and an Attribute Element is symbolized by a rounded rectangle.

The Content-Filter of this exemplary graphical representation of the OPC UA query as depicted in FIG. 2 may be formulated in the following way:
Find all Instances of PersonType, where the Instances are connected to an Instance of AnimalType with a HasPet ReferenceType. In addition, the AnimalType Instance is to be connected to a ScheduleType Instance with a HasSchedule ReferenceType.

The QueryDataSet (dataToReturn) of this example may be formulated in the following way:
Return the LastName Property of the PersonType Instance and the Name Property of the corresponding AnimalType Instance and the Period Property of the ScheduleType Instance.

The following section shows how this query is formulated in SPARQL natively:

```
prefix query: <http://opcfoundation.org/UA/Examples/QueryPart4/>
prefix opcua: <http://opcfoundation.org/UA/>
prefix ia: http://opcfoundation.org/UA/Meta/IA/
SELECT DISTINCT ?nodeId ?lastnameValue ?nameValue ?periodValue
WHERE {
  ?person a: query: PersonType. ?animal a query:AnimalType.
  ?schedule a query:ScheduleType. ?animal query:hasSchedule ?schedule.
  ?person query:hasSPet ?animal.
  ?person ia:nodeId ?nodeld. ?person query:lastname/ia:value ?lastnameValue.
  ?animal query:name/ia:value ?nameValue.
  ?schedule query:period/ia:value ?periodValue
}
LIMIT 25
```

Lines 1-3 define the used Namespaces. The filter statement is described in lines 7-12. The QueryDataSet (dataToReturn) is described in line 5 and lines 11-13.

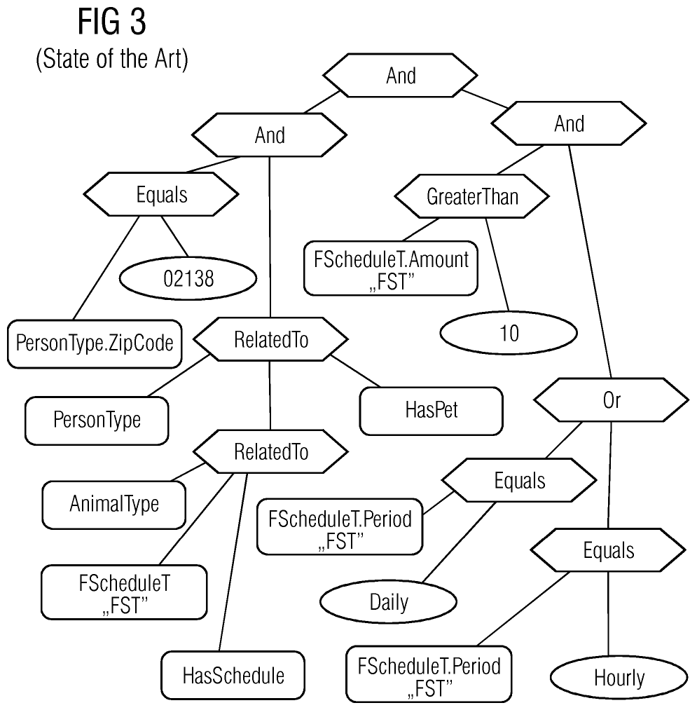

FIG. 3 shows a graphical representation of a logic tree structure for an exemplary OPC UA query illustrated in the specification »OPC Unified Architecture«, Part 4, Annex B. In FIG. 3, an Operator Element is symbolized by a respective rounded hexagon, an Attribute Element is symbolized by a rounded rectangle, and a Literal Element is symbolized by an ellipse.

The Content-Filter of this exemplary graphical representation of the OPC UA query as depicted in FIG. 3 may be formulated in the following way:
Find all Instances of PersonType, where a PersonType is connected to an AnimalType with a HasPet Reference and additionally the AnimalType must be connected to a FeedingSchedule-Type through a HasSchedule Reference. Furthermore, the PersonType Instance shall have a Zipcode-Property with the value “02138”. Finally, the FeedingScheduleType shall have a Period-Property with the value »Daily« or »Hourly« and an Amount-Property with a value greater than »10«.

The following section shows how this query is formulated in SPARQL natively:

```
prefix query: <http://opcfoundation.org/UA/Examples/QueryPart4/>
prefix opcua: <http://opcfoundation.org/UA/>
prefix ia: <http://opcfoundation.org/UA/Meta/IA/>
SELECT DISTINCT ?nodeId ?typeNodeId ?lastnameValue ?nameValue ?periodValue
WHERE {
  ?animal a query: AnimalType. ?schedule a query:FeedingScheduleType.
  ?animal query:hasSchedule ?schedule. ?person a query:PersonType.
  ?person query:hasPet ?animal. ?person query:zipCode/ia:value ?zipCodeValue.
  Filter(?zipCodeValue = “02138”). ?schedule query:period/ia:value ?periodValue.
  Filter((?periodValue = “Hourly”) ∥ (?periodValue = “Daily”)).
  ?schedule query:amount/ia:value ?amountValue. Filter(?amountValue > 10).
  ?person ia:nodeId ?nodeld. ?person opcua:hasTypeDefinition ?typeNodeId.
  ?person query:lastname/ia:value ?lastnameValue. ?animal query:name/ia:value ?nameValue.
}
LIMIT 25
```

Lines 1-3 define the used Namespaces similar to the example of FIG. 2. The filter statement is described in lines 7-12. The QueryDataSet (dataToReturn) is described in line 5 and lines 14-15.

As shown above, the use of SPARQL enables to reuse filter statements in the result statement (e.g., the periodValue). The results of this query are as specified by the OPC UA specification. This SPARQL query is not totally equal to the corresponding OPC UA Query. For example, if the Lastname-Property for JFamily1 is not defined, the whole query would fail; in contrast, OPC UA Query would only return a null-value for the particular QueryDataSet. However, a same behavior may be modelled through adding an OPTIONAL statement in SPARQL, for example, by:
OPTIONAL{?person query:lastname/ia:value ?lastnameValue.}.

The present embodiments enable efficient querying of an aggregated and transformed OPC UA information model. Currently there is no product-ready tool implementation for querying an OPC UA information model available. The embodiments allow for performing query operations imposed to a plurality of industrial entities including skill-matching, onboarding of devices into machinery, data-mining, etc.

A semantic ontology language, amongst other semantic ontology language as RDF, RDFS or RDF schema, is provided by a language family referred to as OWL or Web Ontology Language. The OWL language family is structured in conformance with the XML standard of W3C for objects according to the Resource Description Framework or RDF. OWL in combination with RDF has a wide dissemination in implementing knowledge representation for authoring ontologies.

The elements and features recited in the appended claims may be combined in different ways to produce new claims that likewise fall within the scope of the present invention. Thus, whereas the dependent claims appended below depend from only a single independent or dependent claim, these dependent claims may, alternatively, be made to depend in the alternative from any preceding or following claim, whether independent or dependent, and such new combinations are to be understood as forming a part of the present specification.

While the present invention has been described above by reference to various embodiments, many changes and modifications may be made to the described embodiments. The foregoing description may be regarded as illustrative rather than limiting, and all equivalents and/or combinations of embodiments are intended to be included in this description.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A method for querying industrial data, the method comprising:
receiving, by an endpoint of a query module, a first query expression from a client, the first query expression being expressed by a query language for accessing a semantically enriched and graph-based information model for automation purposes;
transforming, by the endpoint, the first query expression into a second query expression, the second query expression being expressed by a query language for accessing a triple store information model according to a resource description framework (RDF) format, the transforming including retrieving at least one operand of the first query expression, applying at least one transformation rule for the at least one operand, and replacing the at least one operand by at least one statement of the second query expression;
performing, by a query engine, a query on a triple store using the second query expression, the triple store including an aggregated ontology of industrial data; and
returning a query result to the client.

2. The method of claim 1, wherein the semantically enriched and graph-based information model for automation purposes is an OPC UA information model.

3. The method of claim 1, wherein the triple store information model is expressed in an ontology language including OWL, RDF, and RDFS.

4. The method of claim 1, wherein the second query expression is substantially expressed by SPARQL.

5. The method of claim 1, wherein the aggregated ontology of the industrial data includes a static portion and a dynamic portion.

6. The method of claim 5, wherein the static portion includes type-hierarchy data from at least one graph-based information model of at least one industrial entity, and
wherein the type-hierarchy data is transformed into a triple store information model and joined with at least one other transformed type-hierarchy data of at least one other industrial entity data, such that the aggregated ontology is formed.

7. The method of claim 6, wherein the static portion is amended in case that the graph-based information model of at least one of the industrial entities is updated.

8. The method of claim 7, wherein an update of the graph-based information model of at least one of the industrial entities is announced by an event.

9. The method of claim 5, wherein the dynamic part of industrial data includes dynamic assignments of at least one data value gathered from at least one industrial entity at runtime in response to a query, and
wherein the at least one data value is integrated into the aggregated ontology.

10. The method of claim 1, further comprising generating the aggregated ontology generating the aggregated ontology comprising:
gathering the industrial data stored by a graph-based information model for automation purposes amongst industrial entities within an aggregated address space; and
transforming the aggregated address space into the triple store information model according to the RDF format.

11. A query module comprising:
a processor; and
a data storage device having stored thereon computer executable program code that, when executed by the processor, causes the processor to:
receive a first query expression from a client, the first query expression being expressed by a query language for accessing a semantically enriched and graph-based information model for automation purposes;
transform the first query expression into a second query expression, the second query expression being expressed by a query language for accessing a triple store information model according to a resource description framework (RDF) format, wherein the transform includes retrieval of at least one operand of the first query expression, application of at least one transformation rule for the at least one operand, and replacement of the at least one operand by at least one statement of the second query expression;
perform a query on a triple store using the second query expression, the triple store including an aggregated ontology of the industrial data; and
return a query result to the client.

12. In a non-transitory computer-readable storage medium having stored thereon computer executable program code that, when executed by a computer, causes the computer to:
receive a first query expression from a client, the first query expression being expressed by a query language for accessing a semantically enriched and graph-based information model for automation purposes;
transform the first query expression into a second query expression, the second query expression being expressed by a query language for accessing a triple store information model according to a resource description framework (RDF) format, wherein the transform includes retrieval of at least one operand of the first query expression, application of at least one transformation rule for the at least one operand, and replacement of the at least one operand by at least one statement of the second query expression;
perform a query on a triple store using the second query expression, the triple store including an aggregated ontology of said industrial data; and
return a query result to the client.

13. The non-transitory computer-readable storage medium of claim 12, wherein the semantically enriched and graph-based information model for automation purposes is an OPC UA information model.

14. The non-transitory computer-readable storage medium of claim 12, wherein the triple store information model is expressed in an ontology language including OWL, RDF, and RDFS.

15. The non-transitory computer-readable storage medium of claim 12, wherein the second query expression is substantially expressed by SPARQL.

16. The non-transitory computer-readable storage medium of claim 12, wherein the aggregated ontology of the industrial data includes a static portion and a dynamic portion.

17. The non-transitory computer-readable storage medium of claim 16, wherein the static portion includes type-hierarchy data from at least one graph-based information model of at least one industrial entity, and
wherein the type-hierarchy data is transformed into a triple store information model and joined with at least one other transformed type-hierarchy data of at least one other industrial entity data, such that the aggregated ontology is formed.

18. The non-transitory computer-readable storage medium of claim 17, wherein the static portion is amended in case that the graph-based information model of at least one of the industrial entities is updated.

19. The non-transitory computer-readable storage medium of claim 18, wherein an update of the graph-based information model of at least one of the industrial entities is announced by an event.
